(19) United States
(12) Patent Application Publication
(10) Pub. No.: US 2009/0183658 A1
(43) Pub. Date: Jul. 23, 2009

(54) Vault cover with vault door and spring-biased support arm

(75) Inventors: Lawrence S. McDougle, Oceanside, CA (US); Scott Higley, San Marcos, CA (US)

Correspondence Address: STETINA BRUNDA GARRED & BRUCKER, 75 ENTERPRISE, SUITE 250, ALISO VIEJO, CA, 92656, US

(73) Assignee: Lasco Lids, Inc.

(21) Appl. No.: 12/009,893

(22) Filed: Jan. 23, 2008

(51) Int. Cl. E05G 1/026; E05G 1/04

(52) U.S. Cl. 109/59 T

(57) ABSTRACT

There is provided a vault cover assembly including a vault frame and a vault door. The vault door is pivotally connected to the vault frame. The vault door is pivotable between open and closed positions relative to the vault frame. A spring-biased support arm is connected to the vault door and is moveable between locked and unlocked configurations relative to the vault door. The spring-biased support arm is biased toward the locked configuration. The spring-biased support arm includes a locking member that is engageable with the vault frame when the spring-biased support arm is in the locked configuration. The vault door is disposed in the open position upon engagement between the locking member and the vault frame. The vault door is pivotable between the open and closed positions when the spring-biased support arm is in the unlocked configuration.

### CROSS-REFERENCE TO RELATED APPLICATIONS

(Not Applicable)

### STATEMENT RE: FEDERALLY SPONSORED RESEARCH/DEVELOPMENT

(Not Applicable)

### BACKGROUND OF THE INVENTION

1. Field of the Invention

The present invention relates generally to vault covers assemblies and more particularly, to a vault cover assembly having a vault door configured to remain in an open position to provide access to a vault.

2. Description of the Related Art

Many of today's modern utilities typically include a complex support network. For instance, communications, electricity, gas, steam, and sewage systems are exemplary utilities which include intricate support networks. In many cases, the support network is located underground for aesthetic, safety and security reasons. Each support network may include a number of subterranean rooms, referred to as utility vaults, spread throughout the network to provide access to each network.

The utility vaults may be used to store connections and controls related to the particular system. For instance, the utility vault may include valves for water and natural gas systems, and switchgear for electrical and communications systems. Routine operation and maintenance of the utility systems may be conducted from the utility vaults.

A vault typically includes a vault frame embedded within the ground, and a vault door. The vaults are commonly positioned in or near streets and sidewalks. Consequently, the vault may be configured to withstand vehicular and foot traffic. As a result, the vault doors tend to be very heavy and robust.

As a result of the considerable weight of the vault doors, opening the doors can be very difficult. Once the doors are open, the door has a tendency to close very quickly making it very difficult for a utility worker to get into the vault. Furthermore, many vault doors are configured to lock when they are closed. Therefore, if the vault door closes while a worker is in the vault, the worker may be trapped in the vault. Even if the vault door does not automatically lock when closed, the large weight of the door may make it difficult for the worker located within the vault to open it from the inside, which effectively traps the worker therein. Therefore, an additional worker may be required in order to hold the door open so as not to trap a worker within the vault.

As is apparent from the foregoing, there exists a need in the art for a door for a utility vault which may be maintained an open position. The present invention addresses this particular need, as will be discussed in more detail below.

### BRIEF SUMMARY OF THE INVENTION

According to an aspect of the present invention, there is provided a vault cover assembly including a vault frame and a vault door. The vault door is pivotally connected to the vault frame. The vault door is pivotable between open and closed positions relative to the vault frame. A spring-biased support arm is connected to the vault door and is moveable between locked and unlocked configurations relative to the vault door. The spring-biased support arm is biased toward the locked configuration. The spring-biased support arm includes a locking member that is engageable with the vault frame when the spring-biased support arm is in the locked configuration. The vault door is disposed in the open position upon engagement between the locking member and the vault frame. The vault door is pivotable between the open and closed positions when the spring-biased support arm is in the unlocked configuration.

An aspect of the present invention enables a vault door to remain in an open position. The spring-biased support arm may support the vault door when the spring-biased support arm is in the locked configuration. Thereafter, the spring-biased support arm may be moved into the unlocked configuration to allow the door to close. In this manner, a utility worker may open the vault door and enter the vault without having the vault door close while the worker is in the vault.

The vault door assembly may include a guide post engaged between the spring-biased support arm and the vault door to align the locking member for engagement with the vault frame. The guide post may protrude from and be integrally formed with the spring-biased support arm. The vault door may define a guide aperture which engages with the guide post.

The vault door assembly may further include a fastener connecting the spring-biased support arm to the vault door. The fastener may include an arm biasing element configured to bias the spring-biased support arm towards the locked configuration. The arm biasing element may be a helical spring defining a central spring axis and the fastener may define a fastener axis. The fastener axis may be aligned with the central spring axis.

The spring-biased support arm may define an arm fastening hole and the vault door may define a door fastening hole. The fastener may be disposed within the arm fastening hole and the door fastening hole to connect the spring-biased support arm to the vault door. The fastener may include a bolt having a head portion and a shank portion. The shank portion may be disposed within the arm and door fastening holes and be moveable within the door fastening hole as the spring-biased support arm moves between the locked and unlocked configurations.

The present invention is best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings in which like numbers refer to like parts throughout and in which:

FIG. 1 is a top perspective view of a vault cover assembly including a vault frame and two vault doors and a spring-biased support arm connected to each vault door to maintain the vault door in an open position, each vault door being in an open position;

FIG. 2 is an enlarged perspective view of the vault cover assembly, the spring-biased support arm being in a locked configuration;

FIG. 3 is an enlarged perspective view of the vault cover assembly of FIG. 2, the spring biased support arm being in an unlocked configuration; and

FIG. 4 is an exploded perspective view of the vault cover assembly.

### DETAILED DESCRIPTION OF THE INVENTION

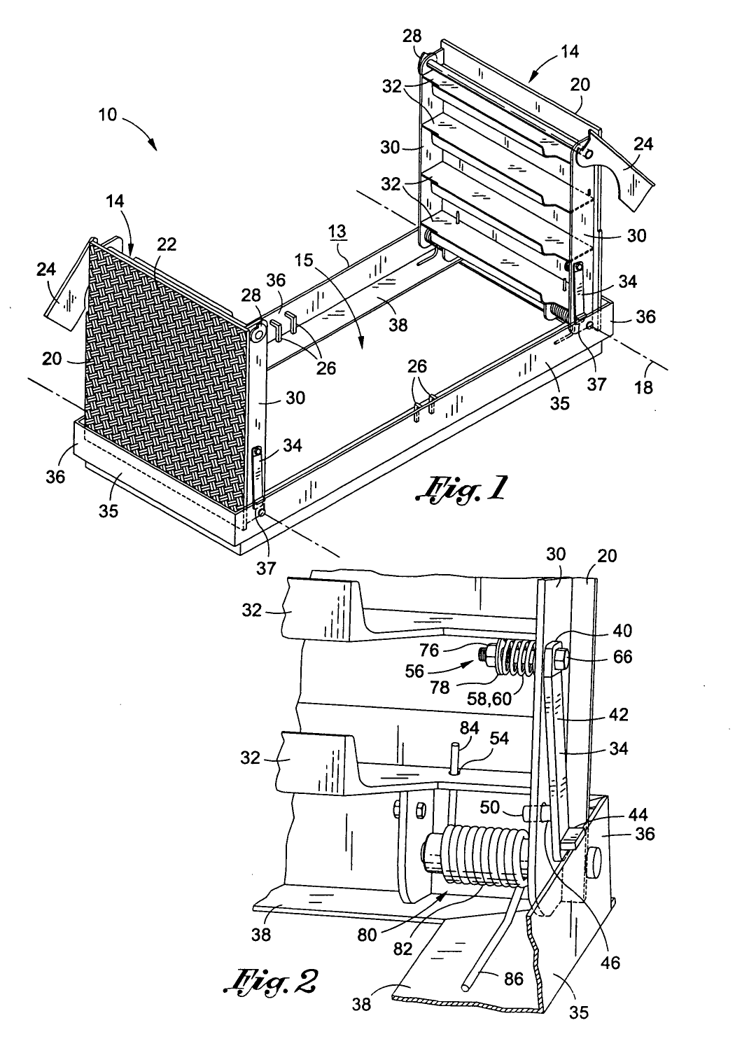

Referring now to the drawings wherein the showings are for purposes of illustrating a preferred embodiment of the present invention only, and not for purposes of limiting the same, FIGS. 1-4 illustrate a vault cover assembly 10 constructed in accordance with an aspect of the present invention. The vault cover assembly 10 includes a vault frame 12 and a vault door 14 pivotally connected to the vault frame 12. The vault frame 12 is typically embedded within a surrounding ground surface. It may be desirable to embed the vault frame 12 so that the vault frame top surface 13 is flush with the surrounding ground surface. The vault frame 12 defines a vault opening 15 which provides access to an underground utility vault. In other words, a utility worker may enter the utility vault via the vault opening 15.

The vault frame 12 includes a plurality of vault frame rails 35. Each vault frame rail 35 may include a vertical portion 36 and a horizontal portion 38. The vertical and horizontal rail portions 36, 38 may be disposed perpendicularly relative to each other, as shown in the FIGS. 1-4, or they may have some other angular disposition. In the embodiment shown in FIG. 1, the vault frame 12 includes four vault frame rails 35 arranged perpendicularly relative to each other to define a rectangular vault opening 15. However, it is understood that the vault frame rails 35 may be sized and configured to define a vault opening 15 that is any size and shape.

The vault cover assembly 10 includes a vault door 14. In the embodiment shown in FIG. 1, the vault cover assembly 10 includes two vault doors 14. It is understood that any number of vault doors 14 may be used without departing from the spirit and scope of the present invention. The vault door 14 is pivotable about a door pivot axis 18. Given that most vault frames 12 are embedded within the ground, most vault doors 14 pivot about a non-vertical pivot axis 18. The doors 14 pivot between an open position and a closed position relative to the vault frame 12. The doors 14 are moved into the open position to provide access into the utility vault via the vault opening 15. In the closed position, the doors 14 cover the vault opening 15 to restrict access into the utility vault. When more than one vault door 14 is included, the plurality of doors 14 collectively cover the vault opening 15. In one implementation of the invention, the vault doors 14 are flush with the top surface 13 of the vault frame 12 when the vault doors 14 are in the closed position to provide a smooth transition between the vault frame 12 and the vault door 14.

Vault cover assemblies 10 are commonly embedded within streets and sidewalks to provide easy access for utility workers. As such, the vault cover assembly 10 may be configured to withstand vehicular and pedestrian traffic. Therefore, the vault doors 14 tend to be very heavy and robust. The vault doors 14 depicted in FIGS. 1-4 include a planar door panel 20 and opposing door rails 30. The exterior surface of the planer door panel 20 interfaces with the passing traffic. It is common for planar door panels 20 to include a tread pattern 22 on the exterior surface to enhance the grip between the passing traffic and the vault door 14. The tread pattern 22 may be diamond-shaped, or other shapes known by those skilled in the art, and may be extruded or engraved. The tread pattern 22 may be provided for increasing the traction over the smooth metallic surface of the vault door 14. This is particularly important in wet environments where loss of traction in relation to vehicle or pedestrian traffic may have disastrous consequences. The vault doors 14 may further include one or more support ribs 32 to enhance the strength of the door 14. The support ribs 32 extend below the planar door panel 20 and are connected to the opposing door rails 30.

According to an aspect of the present invention, the vault cover assembly 10 is configured to maintain the door 14 in the open position. In one embodiment, the vault door 14 is maintained in the open position by a spring-biased support arm 34. In this manner, the support arm 34 is configured to support the vault door 14 when the vault door 14 is in the open position. More specifically, the spring-biased support arm 34 engages both the vault frame 12 and the vault door 14 when the vault door 14 is in the open position to maintain the vault door 14 in the open position. Therefore, the vault door 14 may be maintained in the open position while the utility worker is in the utility vault. In this regard, the utility worker may not have to worry about having the door close while the worker is in the vault.

In one embodiment, the spring-biased support arm 34 is connected to the vault door 14. As shown in FIGS. 1-4, the spring-biased support arm 34 is connected to the door rail 30 of the vault door 14. The spring-biased support arm 34 is moveable between a locked configuration and an unlocked configuration. According to one embodiment, the spring-biased support arm 34 is configured to be biased toward the locked configuration, as described in more detail below. In the locked configuration, the spring-biased support arm 34 may engage the vault frame 12 to prevent rotation of the vault door 14 from the open position toward the closed position. When the support arm 34 is in the unlocked configuration, the vault door 14 may pivot freely. In other words, the support arm 34 does not restrict pivotal motion of the vault door 14 when the support arm 34 is in the unlocked configuration. Therefore, when user desires to move the vault door 14 into the closed position, the support arm 34 is moved into the unlocked-configuration.

It may be desirable to incorporate the support arm 34 into a foot latch. Since many vault frames 12 are embedded within the ground, the support arm 34 may engage with the vault frame 12 at ground level. Therefore, when a user wants to close the door 14, it may be convenient to move the support arm 34 into the unlocked configuration with the user's foot.

One aspect of the invention includes a spring-biased support arm 34 having a locking member 44 which engages with the vault frame 12 when the support arm 34 is in the locked configuration. When the spring-biased support arm 34 is in the locked configuration, the locking member 44 may be placed in contact with the vault frame top surface 13. The locking member 44 may be integrally formed with the spring-biased support arm 34 or detachably engaged thereto. Although the particular locking member 44 depicted in FIGS. 1-4 is rectangular in shape, it is contemplated that the locking member 44 may be sized and configured to be any shape, so long as it may engage with the vault frame 12 to maintain the vault door 14 in the open position.

FIGS. 1-4 show the locking member 44 attached to the support arm 34; however, it is contemplated that other aspects of the invention may include a locking member 44 connected to the vault frame 12. In this manner, the support arm 34 may be engageable with the locking member 44 when the spring-biased support arm 34 is in the locked configuration. For instance, the locking member 44 may protrude from the vault frame 12. The spring-biased support arm 34 may include a slot which engages with the locking member 44 when the support arm 34 is in the locked configuration. The engagement of the locking member 44 and the slot on the support arm 34 may maintain the vault door 14 in the open position. The support arm 34 may subsequently be disengaged with the locking member 44 to enable the vault door 14 to pivot toward the closed position.

The spring-biased support arm 34 may include a first planar portion 40 and a second planar portion 42. The first planar portion 40 defines a first plane, while the second planar portion 42 defines a second plane that is angularly disposed relative to the first plane. The angular disposition may define the amount of support arm 34 movement between the locked and unlocked configurations. In other words, as the angular disposition of the first planar portion 40 relative to the second planar portion 42 increases, the range of motion of the support arm 34 between the locked and unlocked configurations may also increase.

The support arm 34 may be configured to substantially maintain the planar disposition of the first planar portion 40 relative to the second planar portion 42 during use of the vault cover assembly 10. In other words, the support arm 34 may be configured to mitigate deformation of the first planar portion 40 relative to the second planar portion 42.

The spring-biased support arm 34 may be secured to the vault door 14 by a fastener 56. In the embodiment depicted in FIGS. 2-4, the fastener 56 includes a bolt 66 having a head portion 68 and a shank portion 70. The support arm 34 may include an arm fastening hole 72 and the vault door 14 may include a door fastening hole 74. The door fastening hole 74 may be located on the door rail 30. However, it is understood that the door fastening hole 74 may be positioned at other locations on the vault door 14 without exceeding the scope of the present invention. The arm and door fastening holes 72, 74 may be aligned to allow the fastener 56 to pass therethrough to fasten the support arm 34 to the vault door 14.

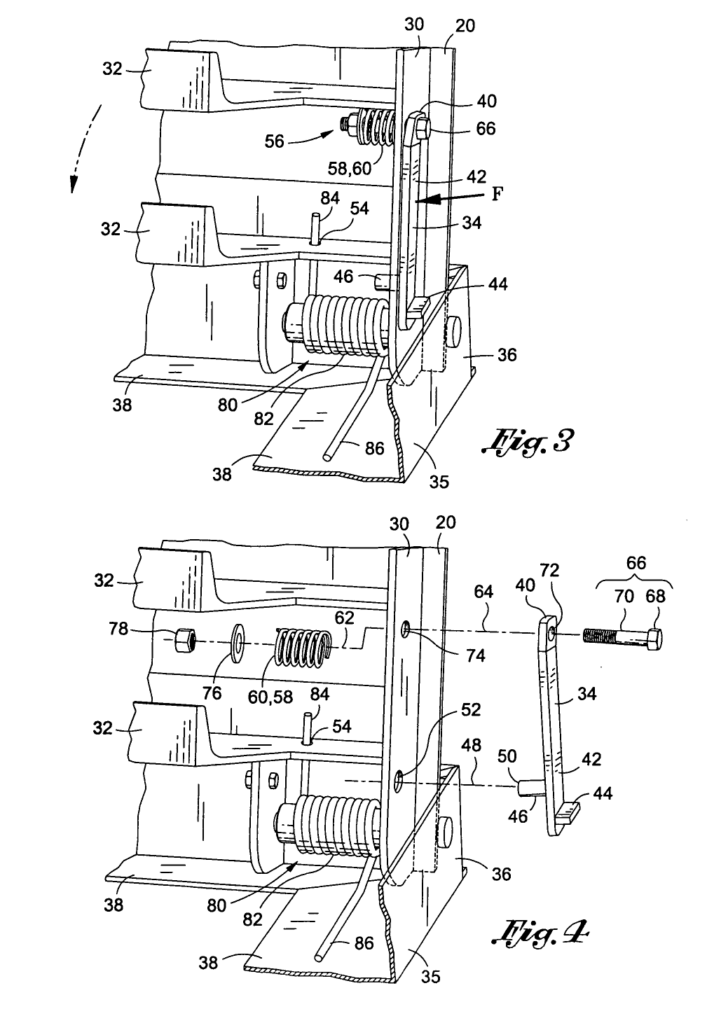

The fastener 56 may further include an arm biasing element 58 configured to bias the spring-biased support arm 34 toward the locked configuration. As shown in FIGS. 1-4, the arm biasing element 58 is a helical spring 60. The helical spring 60 defines a central axis 62 and the fastener 56 defines a fastener axis 64. In one embodiment, the central axis 62 of the helical spring 60 is aligned with the fastener axis 64. Therefore, the bolt 66 may be disposed within the helical spring 60, as best shown in FIGS. 2 and 3. More specifically, the shank portion 70 of the bolt 66 is disposed within the helical spring 60.

In the particular embodiment shown in FIGS. 1-4, the fastener 56 further includes a nut 78 threadingly engaged to the shank portion 70 of the bolt 66. A washer 76 is positioned between the nut 78 and the door rail 30. Furthermore, the spring 60 is disposed between the washer 76 and the door rail 30. The spring 60 urges the washer 76 and nut 78 away from the door rail 30, which in turn pulls the head portion 68 of the bolt 66 toward the door rail 30. As the head portion 68 is pulled toward the door rail 30, the support arm 34 is urged toward the locked position. When the support arm 34 moves from the locked configuration toward the unlocked configuration, the spring 60 is compressed. As the spring 60 compresses, the biasing force urging the support arm 34 toward the locked configuration increases. Moreover, when the support arm 34 moves from the unlocked configuration toward the locked configuration, the spring 60 expands.

According to another aspect of the invention, the vault cover assembly 10 further includes a guide post 46 defining a post longitudinal axis 48. The guide post 46 is engaged between the support arm 34 and the vault door 14. The guide post 46 is configured to align the support arm 34 for engagement with the vault frame 12. If the vault cover assembly 10 does not include a guide post 46, the support arm 34 may rotate about the fastener 56 and out of alignment with the vault frame 12. Therefore, the guide post 46 is configured to mitigate such rotation of the support arm 34. It is contemplated that the guide post 46 engages with a guide aperture 52. The guide post 46 may include a post distal end 50 which translates along the post longitudinal axis 48 as the spring-biased support arm 34 moves between the locked and unlocked configurations.

In one embodiment the guide post 46 protrudes from the spring biased support arm 34 and the guide aperture 52 is defined by the vault door 14. As shown in FIGS. 2-4, the guide post 46 and the locking member 44 are both located on the second planar portion 42 of the spring-biased support arm 34. The guide aperture 52 is located within the door rail 30 of the vault door 14. It is contemplated that the guide post 46 may be integrally formed with the support arm 34 or detachably connected thereto. As the support arm 34 moves between the locked and unlocked configurations, the guide post 46 moves within the guide aperture 52.

In another embodiment, the guide post 46 protrudes from the vault door 14, while the guide aperture 52 is defined by the spring-biased support arm 34. In this manner, the guide aperture 52 moves as the support arm 34 moves. In other words, the guide aperture 52 moves along the guide post 46 as the support arm 34 moves between the locked and unlocked configurations.

When the support arm 34 is placed in the unlocked configuration, the vault door 14 may pivot to the closed position. In one embodiment, the vault door 14 is configured to automatically lock when placed in the closed position. The vault door 14 may include a lever lock 24 pivotally engaged thereto, as shown in FIG. 1. The lever lock 24 engages with a lever engagement member 26 to lock the vault door 14 in the closed position. The vault door 14 may additionally include an auxiliary lever 28 which also engages with a lever engagement member 26. The lever lock 24 and the auxiliary lever 28 may be pivotally connected to the door rail 30 as shown in FIG. 1. A specialized tool may be required to disengage the lever lock 24 and the auxiliary lever 28 from respective lever engagement members 26. When the lever lock 24 and the auxiliary lever 28 are disengaged, the vault door 14 may be moved from the closed position toward the open position.

As mentioned earlier, the vault door 14 tends to be very heavy and robust making it difficult to open. Therefore, the vault cover assembly 10 may include a lift assist 80 to help a user open the vault door 14. The lift assist 80 may be engaged to both the vault door 14 and the vault frame 12. In one particular embodiment, the lift assist 80 may include an assist spring 82. The assist spring 82 may include a door assist element 84 which engages with the vault door 14 and a frame assist element 86 which engages with the vault frame 12. As shown, the vault door 14 includes a door assist aperture 54 located within one of the support ribs 32. The door assist aperture 54 engages with the door assist element 84 of the assist spring 82 and the frame assist element 86 engages with the vault frame 12. In the embodiment depicted in FIGS. 1-4, the frame assist element 86 engages with the horizontal frame rail 38; however, it is understood that the frame assist element 86 may also engage with the vertical frame rail 36.

With respect to the embodiment depicted in FIGS. 1-4, the door rails 30 are disposed inwardly of the vertical frame rails 36 to allow the doors 14 to pivot relative to the vault frame 12. As such, the support arm 34 is biased outwardly toward the frame rail 35. However, in other embodiments, the door rails 30 may be disposed outwardly of the vertical frame rails 36. In that case, the support arm 34 would be biased inwardly (i.e., toward the vault opening 15).

As the vault door 14 moves between the closed and open positions, the support arm 34 is in the unlocked configuration, and the locking member 44 may be in contact with the inner surface of the vertical frame rail 38. The embodiment shown in FIG. 1 includes two vault doors 14. The support arms 34 connected to each vault door 14 are located on a common side. In other words, the support arms 34 contact a common frame rail 35. However, it is understood that the support arms 34 may be in contact with different frame rails 35.

The locking member 44 is inward of the vertical frame rail 36 until the door 14 pivots past the open position. Once the vault door 14 pivots past the open position, the support arm 34 is biased outwardly thereby placing the locking member 44 in position to engage with the vault frame 12. The support arm 34 may include a restriction portion 37 to prevent the locking member 44 from biasing past the vault frame 12. In the embodiment shown in FIGS. 1, the restriction portion 37 extends below the locking member 44. In this manner, the restriction portion 37 may be placed in contact with the vertical frame rail 36 to further align the locking member 44 with the vault frame 12.

The locking member 44 may also be aligned with the vault frame 12 by the angular disposition of the first planar portion 40 relative to the second planar portion 42. In other words, once the first planar portion 40 is flush with the door rail 30, the locking member 44 may not move outwardly past the vault frame 12. Therefore, the locking member 44 may be aligned with the vault frame 12 to maintain the vault door 14 in the open position.

When in the open position, the locking member 44 engages with the vault frame 12. As illustrated in FIGS. 1 and 2, the locking member 44 engages with the top surface 13 of the vault frame 12. In order to pivot the vault door 14 from the open position to the closed position, the locking member 44 disengages with the vault frame 12 by moving the support arm 34 from the locked configuration into the unlocked configuration. The support arm 34 may be placed in the unlocked configuration by applying a force “F” to the support arm 34. When the force F is applied, the first planar portion 40 may be moved from flush, abutting contact with the door rail 30. As the first planar portion 40 disengages, the bolt head portion 68 is moved away from the door rail 30, as best shown in FIG. 3. As the bolt head portion 68 moves away from the door rail 30, the helical spring 60 is compressed. Once the support arm 34 is in the unlocked configuration, the locking member 44 is disengaged from the vault frame 12 thereby allowing the vault door 14 to pivot toward the closed position. It is contemplated that the force F may be applied by a user's foot due to the fact that the support arm 34 will likely be positioned very close to ground level. However, it is understood that the force F may be applied by other means known by those skilled in the art.

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A vault cover assembly comprising:
a vault frame;
a vault door pivotally connected to the vault frame, the vault door being pivotable between open and closed positions relative to the vault frame; and
a spring-biased support arm being connected to the vault door and being moveable between locked and unlocked configurations relative to the vault door, the spring-biased support arm being biased toward the locked configuration, the spring-biased support arm having a locking member that is engageable with the vault frame when the spring-biased support arm is in the locked configuration, the vault door being disposed in the open position upon engagement between the locking member and the vault frame, the vault door being pivotable between the open and closed positions when the spring-biased support arm is in the unlocked configuration.

2. The vault cover assembly of claim 1 further includes a guide post being engaged between the spring-biased support arm and the vault door to align the locking member for engagement with the vault frame.

3. The vault cover assembly of claim 2 wherein the guide post defines a post longitudinal axis, the guide post has a post distal end which translates along the post axis as the spring-biased support arm moves between the locked and unlocked configurations.

4. The vault cover assembly of claim 2 wherein the guide post protrudes from the spring-biased support arm.

5. The vault cover assembly of claim 4 wherein the guide post is integrally formed with the spring-biased support arm.

6. The vault cover assembly of claim 4 wherein the vault door defines a guide aperture engaged with the guide post.

7. The vault cover assembly of claim 2 further includes a fastener pivotally connecting the spring-biased support arm to the vault door

8. The vault cover assembly of claim 1 further includes a fastener pivotally connecting the spring-biased support arm to the vault door.

9. The vault cover assembly of claim 8 wherein the fastener includes an arm biasing element configured to bias the spring-biased support an-n towards the locked configuration.

10. The vault cover assembly of claim 8 wherein arm biasing element is a helical spring defining a central spring axis.

11. The vault cover assembly of claim 10 wherein the fastener defines a fastener axis aligned with the central spring axis.

12. The vault cover assembly of claim 8 wherein the spring-biased support arm defines an arm fastening hole and the vault door defines a door fastening hole, the fastener is disposed within the arm fastening hole and the door fastening hole to connect the spring-biased support arm to the vault door.

13. The vault cover assembly of claim 12 wherein the fastener includes a bolt having a head portion and a shank portion, the shank portion is disposed within the arm and door fastening holes and being moveable within the door fastening hole as the support arm moves between the locked and unlocked configurations.

14. The vault cover assembly of claim 1 wherein the vault door is biased towards the closed position.

15. The vault cover assembly of claim 14 further includes a vault spring connected to the vault frame and the vault door, the vault spring being configured to bias the vault door toward the closed position.

16. A vault cover assembly comprising:
a vault frame defining a vault opening;
a pair of vault doors pivotally connected to the vault frame, each of the vault doors being pivotable between open and closed positions relative to the vault frame; and
a pair of spring-biased support arms, each spring-biased support arm being connected to a respective one of the pair of vault doors and being moveable between locked and unlocked configurations relative to the respective vault door, each spring-biased support arm being biased toward the locked configuration, each spring-biased support arm having a locking member that is engageable with the vault frame when the respective spring-biased support arm is in the locked configuration, each vault door being disposed in the open position upon engagement between the respective locking member and the vault frame, each respective vault door being pivotable between the open and closed positions when the respective spring-biased support arm is in the unlocked configuration.

17. The vault cover assembly of claim 16 further includes a pair of fasteners, each fastener pivotally connecting a respective one of the pair of spring-biased support arms to a respective one of the pair of vault doors.

18. The vault cover assembly of claim 17 wherein each fastener includes an arm biasing element configured to bias a respective one of the pair of spring-biased support arms toward the locked configuration.

19. The vault cover assembly of claim 16 further includes a pair of guide posts, each guide post being engaged between a respective spring-biased support arm and a respective vault door to align the locking member of the respective spring-biased support arm for engagement with the vault frame.

20. The vault cover assembly of claim 19 wherein each guide post protrudes from a respective one of the pair of spring-biased support arms.
